(19) United States
(12) Patent Application Publication
(10) Pub. No.: US 2014/0058618 A1
(43) Pub. Date: Feb. 27, 2014

(54) METHODS AND SYSTEMS FOR VEHICLE VALUATION FROM OBD BASED OPERATION DATA

(71) Applicant: Zubie, Inc., Bloomington, MN (US)

(72) Inventors: Michael John Rude, Excelsior, MN (US); Ari Abram Silkey, Burnsville, MN (US)

(73) Assignee: Zubie, Inc., Bloomington, MN (US)

(21) Appl. No.: 13/972,428

(22) Filed: Aug. 21, 2013

Related U.S. Application Data
(60) Provisional application No. 61/691,987, filed on Aug. 22, 2012.
(60) Provisional application No. 61/749,620, filed on Jan. 7, 2013.

(51) Int. Cl. G06F 17/00

(52) U.S. Cl. CPC G06F 17/00
USPC 701/31.4; 701/29.1

(57) ABSTRACT

One embodiment is directed to a method for valuating a vehicle. The method includes obtaining operation data from an on-board diagnostics (OBD) port of a vehicle, the operation data pertaining to operation of the vehicle. The method also includes determining a measure of value for the vehicle based on the operation data, and generating a report including the measure of value.

### CROSS-REFERENCE TO RELATED APPLICATIONS

This application claims the benefit of U.S. Provisional Patent Application Ser. No. 61/691,987, filed on Aug. 22, 2012, and to U.S. Provisional Patent Application Ser. No. 61/749,620, filed on Jan. 7, 2013, both of which are hereby incorporated herein by reference.

### BACKGROUND

Vehicle valuation typically takes into consideration easily obtainable information regarding a vehicle to determine a value. Such information includes the mileage, age, make, model, and appearance of the vehicle. More advanced valuations can take into account any accidents a vehicle has been involved in, its repair history, and/or ownership history. Since vehicle accident history, repair history, and ownership history may not be evident from examining the vehicle at the time of sale, entities exist that can obtain such information and provide a report including the information to anyone with an interest or potential interest in the vehicle.

### SUMMARY

One embodiment is directed to a method for valuating a vehicle. The method includes obtaining operation data from an on-board diagnostics (OBD) port of a vehicle, the operation data pertaining to operation of the vehicle. The method also includes determining a measure of value for the vehicle based on the operation data, and generating a report including the measure of value.

### DRAWINGS

FIG. 1 is a block diagram of an example system for vehicle valuation from OBD based data.

FIG. 2 is a block diagram of an example vehicle telematics device for use in the system of FIG. 1.

FIG. 3 is a block diagram of another example vehicle for use with the vehicle telematics device of FIG. 2.

FIG. 4 is a block diagram of an example data management server for use in the system of FIG. 1.

### DETAILED DESCRIPTION

Embodiments described herein provide for systems and methods for obtaining data from an on-board diagnostics port of a vehicle and using such data for vehicle valuation and for performing valuation related activities.

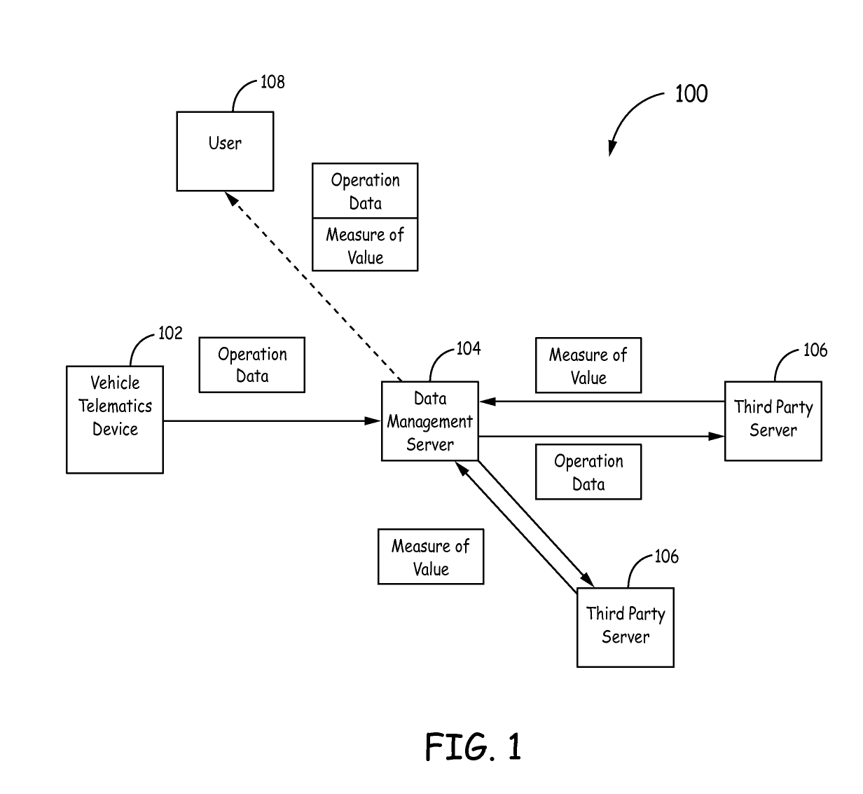

FIG. 1 is a block diagram of an example of such a system 100. System 100 includes a vehicle telematics device 102, a data management server 104, and third parties 106 (e.g., third party server). The vehicle telematics device 102 is configured to obtain or otherwise generate operation data corresponding to a vehicle with which the vehicle telematics device 102 is associated. Operation data includes any data corresponding to the operation of the vehicle, such as data related to speed, braking, acceleration, deceleration, fuel level, oil change intervals, mileage, diagnostic alerts, RPM, various sensor temperatures, flow rates, trims, voltages, pressures, driving duration, location, elevation, or any other available diagnostic data.

The vehicle telematics device 102 sends the operation data obtained or otherwise generated to the data management server 104. The vehicle telematics device 102 can send the operation data to the data management server 104 in any suitable manner, such as by wirelessly transmitting the data from the vehicle telematics device 102 to a cellular tower, which routes the data to the data management server 104 over the internet. In another example, the vehicle telematics deice 102 is configured to communicate with a local area network using, for example, Wi-Fi, where the local area network is coupled to the internet such that the operation information can be provided to the data management server 104. In yet another example, the vehicle telematics device 102 is configured to communicate with a personal computing device (e.g., via USB) that can be coupled to the internet and relay the operation data from the vehicle telematics device 102 to the data management server 104.

The vehicle telematics device 102 can be configured to upload the operation data to the data management server 104 on a real-time, periodic, or on-demand basis. For example, in implementations where the vehicle telematics device 102 is capable of connecting to a cell tower, the operation data can be uploaded to the data management server 104 in real-time. In other examples, the vehicle telematics device 102 can buffer the operation data and periodically upload the operation data.

The data management server 104 receives the operation data from the vehicle telematics device 102 and provides the operation data to one or more third parties 106 for processing. The one or more third parties 106 can process the operation data to determine a measure of value for the vehicle, such as a market price for the vehicle, operational condition for the vehicle, and an amount of wear and tear for the vehicle over a time period. The data management server 104 can store the operation data in a database or other file system associating the operation data with the vehicle and/or a user's account. The data management server 104 can maintain a database include multiple such associations for operation data corresponding to multiple users.

In addition to sending operation data, the vehicle telematics device 102 can also information identifying itself to the data management server 104. The data management server 104 can use this information to associate the vehicle telematics device 102 and the operation data therefrom with a user account. The user account can include information such as the name and address of a user, the vehicle(s) with which the vehicle telematics device is being used, identification information (e.g., serial numbers) for the vehicle telematics devices used by the user, as well as other information. In some examples, the vehicle telematics device 102 can also send information identifying the vehicle to which it is connected, such as a make, model, or vehicle identification (VIN) number. The data management server 104 can use such information to verify which vehicle the vehicle telematics device 102 is connected to. In some examples, the vehicle telematics device 102 can also send information to the data management server 104 indicating when or a number of times that the vehicle telematics device 102 is plugged into and/or unplugged from an OBD port. This information can be used to estimate how consistently the vehicle telematics device 102 was used during operation of the vehicle.

In an example, upon receiving operation data from the vehicle telematics device 102, the data management server 104 can automatically send operation data for a particular user 108 to one or more third parties 106 based on previous instructions. In another example, the data management server 104 can provide a list of options to the user 108 (e.g., via email or web portal) regarding what actions to take with the user's operation data. The list of options can include a list of other entities to which the operation data can be sent and/or the list of options can include a list of actions to perform with the operation data. Actions in the list of actions can be linked to one or more third parties 106 that can perform the actions. The data management server 104 can then receive a selection from the user 108 as to which one or more entities, and/or which one or more actions the user 108 would like to perform on their operation data. The user 108 can provide the selection via return email or via the web portal. Upon receiving the selection from the user, the data management server 104 can send the operation data to the selected one or more third parties 106.

In some implementations, the data management server 104 can maintain anonymity of the user 108 to the one or more third parties 106. For example, the data management server 104 may provide only the operation data to a third party 106 without information identifying the user 108 and/or vehicle specifically. The data management server 104 may provide limited or general information regarding the user 108 and/or vehicle. This may enable the user 108 to obtain a measure of value from one or more third parties 106 without identifying him or herself to the one or more third parties 106. This may be desirable in situations in which user 108 may not want a measure of value that can have a negative consequence to be public. For example, if a user 108 wants to check and see if operation data obtained from their vehicle will increase or decrease a market price for their vehicle, the user 108 may want to obtain an anonymous market price determination. Using an anonymous market price determination enables the user 108 to not use the determined market price, and not have the third parties 106 link the market price to the user 108 or their vehicle, if the market price has a negative effect. In some examples, the user 108 and the data management server 104 may tailor what operation data is provided to a third party 106.

The entity operating the data management server 104 can receive payment from the third parties 106 and/or from the user. In one example, the third parties 106 to which the operation data is provided can provide a payment to the entity for sending business (e.g., operation data) to that third party 106. In another example, the user 108 can provide a payment to the entity for the services provided to the user 108 with regards to the operation data.

The data management server 104 can receive and store operation data from the vehicle telematics device for any period of time and/or can continuously receive and store operation data. In some examples, the data management server 104 can limit the operation data stored based on an amount and/or length of time. For example, once the operation data from a given vehicle telematics device 102 reaches a threshold amount, the data management server 104 can discard operation data stored in the database and replace the discarded operational data with newly received operation data from the vehicle telematics device 102. In an example, the data management server 104 can discard operation data based on the date/time in which the operation data was recorded by the vehicle telematics device 102. For example, the oldest operation data can be discarded such that the operational database contains the most current subset of operation data. Similarly, in examples where the data management server 104 maintains operation data corresponding to a set length of time, the data management server 104 can store operation data for the most current “X” length of time. Thus, operation data older than “X” length of time is discarded. Other examples are also possible.

The data management server 104 can also provide value added services for the user 108 that are not directly related to vehicle valuation, but are enabled by the accumulated operation data. For example, the data management server 104 can maintain a web-portal as discussed above to which the user 108 can log-in and provide such value added services. The value added services can include information on where the vehicle has been driven, average speed, amount of sudden stops, diagnostic of vehicle problems (e.g., via decoding error codes), and others.

In an example, a measure of value determined by one or more third parties 106 can be provided to another individual or entity having an interest in the vehicle. For example, a seller of a vehicle can provide, via the data management server 104, operation data to a third party 106 to determine a measure of value (e.g., an operational condition) of the vehicle. The third party 106 can determine the operational condition and provide a report including determined operational condition to the user. Upon receiving and approving of the operational condition, the user 108 can either directly provide the report, or authorize the third party 106 to provide the report to another individual or entity interested in purchasing the vehicle. In some examples, the third party 106 can combine the operation data with other data (e.g., previous sales price, etc.) to determine the measure of value.

Such a system and method can be advantageous for sellers and purchasers of a vehicle. It can also be advantageous for a lessor of a vehicle to monitor behavior of a lessee. Other interested entities may include a government or an entity considering providing financing for purchase/lease of the vehicle.

The operation data obtained and provide to a third party 106 can be any set of data. For example, the operation data provided can be all operation data stored in the database at the data management server 104. In another example, only a subset (e.g., the most recent 3-months) of the operation data stored in the database is provided to the third party 106. In yet another example, the vehicle telematics device 102 is only briefly plugged into the vehicle (e.g., for less than 5 minutes, while the vehicle is idling) to obtain a small set of the operation data (e.g., the static parameters) and the small set of operation data is provided to the third party 106.

In some examples, the third party 106 can extrapolate data from outside the time period to which the operation data corresponds. For example, if the operation data provided to the third party 106 corresponds to the most recent 3-months, the third party 106 may be able to extrapolate backwards for the previous 3 years to determine artificial operation data based on patterns in the operation data. The third party 106 can then determine a measure of value based on the operation data and the artificial operation data. In some examples, the extrapolation can look forward and the third party 106 can estimate a future measure of value for the vehicle.

In some examples, a third party 106 can analyze the operation data to determine what service was done to the vehicle and when. This can be included with a report having a measure of value or provided as a separate report.

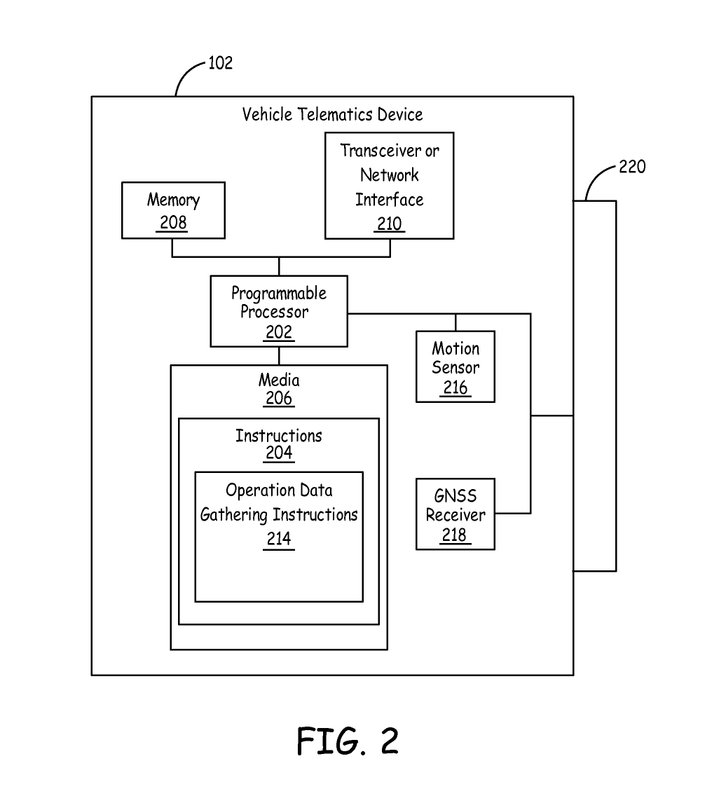

FIG. 2 is a block diagram of an example vehicle telematics device 102. The vehicle telematics device 102 is an electronic device that can be physically attached to a vehicle to obtain operation data. The vehicle telematics device 102 is configured to obtain operation data regarding operation of the vehicle. In an example, the vehicle telematics device 102 is an aftermarket device that can be connected to an on-board diagnostics (OBD) port of the vehicle. Such a vehicle telematics device 102 can obtain operation data by monitoring data sent over one or more of the vehicle electronics busses to which the OBD port is coupled. In another example, the vehicle telematics device 102 can be factory (permanently) built into the vehicle. In this example, the vehicle telematics device 102 can also be coupled to one or more of the vehicle data busses; however, the vehicle telematics device 102 can be built into the vehicle and does not need to be connected to the OBD port. In some examples, the vehicle telematics device 102 can include its own one or more sensors, such as an accelerometer 216, a global navigation satellite system (GNSS) receiver 218 (e.g., a global positioning system (GPS) receiver), and/or a gyroscope, to generate its own operation data in addition to, or instead of, obtaining operation data from the one or more vehicle electronics busses.

The vehicle telematics device 102 includes one or more processing devices 202 for executing instructions 204. The one or more processing devices 22 can include a general purpose processor or a special purpose processor. The instructions 204 are stored (or otherwise embodied) on or in an appropriate storage medium or media 206 (such as flash or other non-volatile memory) from which the instructions 204 are readable by the programmable processor(s) 202 for execution thereby. The vehicle telematics device 102 also includes memory 208 that is coupled to the programmable processor(s) 202 for storing instructions (and related data) during execution by the programmable processor(s) 202. Memory 208 comprises, in one implementation, any suitable form of random access memory (RAM) now know or later developed, such as dynamic random access memory (DRAM). In other implementations, other types of memory are used. The vehicle telematics device 102 also includes a transceiver or network interface 210 for communicatively coupling to other devices/networks. The instructions 204 include operation data gathering instructions 214 that are configured to cause the programmable processor(s) 202 to implement the functions of the vehicle telematics device 102 described above.

In this example, the vehicle telematics device 102 is a third party device configured to be installed in a vehicle and coupled to one or more of the vehicle's data busses through an appropriate connector 220 such as an SAE-J1978 or OBD-II connector. The connector 220 is configured to connect to a complementary SAE-J1978 or OBD-II connector on the vehicle. In addition, the operation data gathering instructions 214 are configured to cause the programmable processor(s) 202 to monitor or provide direct queries to the one or more vehicle data busses through the connector 220. The operation data gathering instructions 214 are also configured to cause the programmable processor(s) 202 to receive data from the sensors 216, 218.

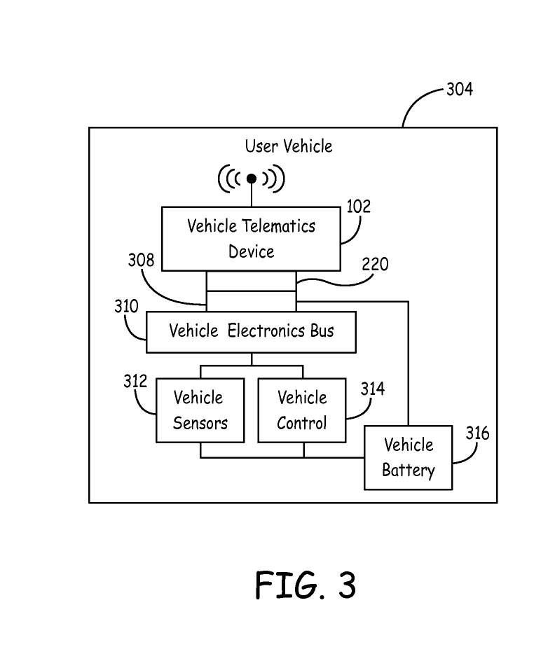

FIG. 3 is a block diagram of an example vehicle 304 including an example vehicle telematics device 102. In this example, the vehicle telematics device 102 is an aftermarket device that is coupled to the one or more vehicle electronics busses 310 through an OBD port of the vehicle 304. The vehicle 304 includes an OBD connector 308 to which the connector 220 can be mated. The OBD connector 308 on the vehicle 304 is coupled to the one or more vehicle electronics busses 310 over which the vehicle sensors 312, vehicle control electronics 314, and other electronics in the vehicle 304 communicate. The vehicle sensors 312 and the vehicle control electronics 314 receive power from a battery 316 in the vehicle 304. As known, this battery 316 can also be the battery that provides power for starting and/or driving the vehicle 304. The battery 316 can also be coupled to a plurality of conductors on the OBD connector 308 of the vehicle 304. These conductors can contact corresponding power conductors on the OBD connector 220 of the vehicle telematics device 102. In this way, the vehicle telematics device 102 can obtain operating power from the battery 316 of the vehicle 304 through the OBD connectors 220, 308. Example OBD connectors 220, 308 include the SAE-J1962 connector, which is the connector for the OBD-II protocol described in the SAE-J1978 standard. The vehicle 304 can include any automobile having an OBD connector 308 including but not limited to, a car, pick-up, SUV, bus, or motorcycle.

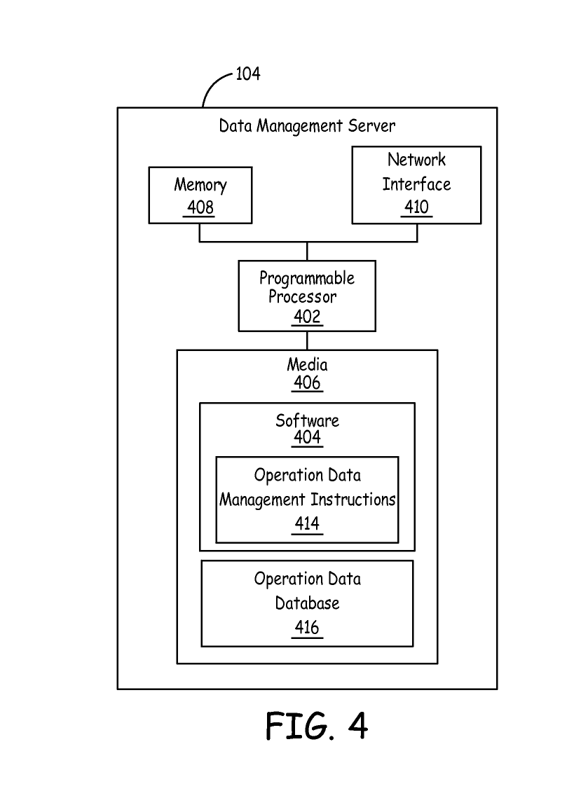

FIG. 4 is a block diagram of an example data management server 104. Server 104 includes one or more processing devices 402 for executing instructions 404. The one or more processing devices 402 can include a general purpose processor or a special purpose processor. The instructions 404 are stored (or otherwise embodied) on or in an appropriate storage medium or media 406 (such as flash or other non-volatile memory) from which the instructions 404 are readable by the programmable processor(s) 402 for execution thereby. The server 104 also includes memory 408 that is coupled to the programmable processor(s) 402 for storing instructions (and related data) during execution by the programmable processor(s) 402. Memory 408 comprises, in one implementation, any suitable form of random access memory (RAM) now known or later developed, such as dynamic random access memory (DRAM). In other implementations, other types of memory are used. The server 104 also includes a network interface 410 for communicatively coupling the server 104 to other devices or networks. The instructions 404 include operation data management instructions 414 that are configured to cause the programmable processor(s) 202 to implement the functions of the data management server 104 described above. Also on the media 406 is the operation data database or other file structure 416 that includes the operation data, user identification information, identification information for the vehicle telematics device 102, as well as their associations.

What is claimed is:

1. A method for valuating a vehicle, the method comprising:
obtaining operation data from an on-board diagnostics (OBD) port of a vehicle, the operation data pertaining to operation of the vehicle;
determining a measure of value for the vehicle based on the operation data; and
generating a report including the measure of value.

2. The method of claim 1, wherein the measure of value comprises a market price for the vehicle.

3. The method of claim 1, wherein the measure of value comprises an operational condition of the vehicle.

4. The method of claim 1, wherein the measure of value comprises an amount of wear-and-tear for the vehicle over a time period.

5. The method of claim 4, wherein the time period is a time period of operation of the vehicle to which the operation data corresponds.

6. The method of claim 1, wherein the operation data corresponds to one or more time periods of operation of the vehicle;
wherein determining the measure of value includes extrapolating, from the operation data, operational information for time periods outside the one or more time periods to which the operation data corresponds.

7. The method of claim 1, wherein obtaining operation data includes recording operation data for the vehicle over a time period of operation of the vehicle.

8. The method of claim 1, wherein a vehicle telematics device is configured to be installed in a vehicle and connected to an OBD-II connector of the vehicle to obtain operation data therefrom, wherein the device is configured to send the operation data to a server.

9. The method of claim 8, wherein the vehicle telematics device is configured to sense motion of the vehicle and include data from the motion with the operation data.

10. A system for valuating a vehicle comprising:
a vehicle telematics device configured to connect to an on-board diagnostics (OBD) port of the vehicle and obtain operation data corresponding to the vehicle from the OBD port;
a data management server configured to receive operation data from the vehicle telematics device, the data management server configured to:
obtain operation data from an OBD port of a vehicle, the operation data pertaining to operation of the vehicle;
determine a measure of value for the vehicle based on the operation data; and
generate a report including the measure of value.

11. The system of claim 10, wherein the measure of value comprises a market price for the vehicle.

12. The system of claim 10, wherein the measure of value comprises an operational condition of the vehicle.

13. The system of claim 10, wherein the measure of value comprises an amount of wear-and-tear for the vehicle over a time period.

14. The system of claim 13, wherein the time period is a time period of operation of the vehicle to which the operation data corresponds.

15. The system of claim 10, wherein the operation data corresponds to one or more time periods of operation of the vehicle;
wherein determine the measure of value includes extrapolate, from the operation data, operational information for time periods outside the one or more time periods to which the operation data corresponds.

16. The system of claim 10, wherein obtain operation data includes record operation data for the vehicle over a time period of operation of the vehicle.

17. The system of claim 10, wherein the vehicle telematics device is configured to sense motion of the vehicle and include data from the motion with the operation data.

18. A method for valuating a vehicle, the method comprising:
obtaining operation data from an on-board diagnostics (OBD) port of a vehicle, the operation data pertaining to operation of the vehicle;
wirelessly transmitting the operation data from the vehicle to a cellular tower;
receiving the operation data at a data management server;
sending the operation data to a third party for determination of a measure of value for the vehicle;
receiving a measure of value from the third party;
generating a report including the measure of value.

19. The method of claim 18, comprising:
receiving from a user, a selection of one or more third parties in which to send the operation data to; and
sending the operation data to the one or more third parties in response thereto.

20. The method of claim 19, wherein obtaining includes obtaining the operation data with a vehicle telematics device connected to the OBD port of the vehicle, the method comprising:
receiving, at the data management server, identification information from the vehicle telematics device identifying the vehicle telematics device; and
associating the operation data from the vehicle telematics device with a user account based on the information identifying the vehicle telematics device.
